(19) United States
(12) Patent Application Publication
(10) Pub. No.: US 2018/0159780 A1
(43) Pub. Date: Jun. 7, 2018

(54) Technique for Message Flow Shaping

(71) Applicant: Telefonaktiebolaget LM Ericsson (publ), Stockholm (SE)

(72) Inventors: Kurt Essigmann, Aachen (DE); Klaus Turina, Herzogenrath (DE)

(21) Appl. No.: 15/575,601

(22) PCT Filed: Jul. 30, 2015
(86) PCT No.: PCT/EP2015/067566

§ 371 Date: Nov. 20, 2017

(51) Int. Cl. H04L 12/819; H04L 12/801; H04L 12/851; H04L 12/825; H04L 12/823; H04L 12/931

(52) U.S. Cl. CPC H04L 47/21; H04L 47/11; H04L 47/2433; H04L 49/506; H04L 47/263; H04L 47/32; H04L 47/2483

(57) ABSTRACT

A message flow shaping approach for a network element capable of message routing is presented. The network element is configured to receive one or more logical ingress message flows and to output one or more logical egress message flows, wherein a flow priority level is allocated to each ingress and egress message flow. A method implementation of the technique presented herein comprises the step of the determining a message flow congestion state per flow priority level at an egress side of the network element. The method further comprises the step of triggering a message flow shaping operation. The message flow shaping operation is triggered per flow priority level at an ingress side of the network element dependent on the congestion state determined for at least one associated flow priority level at the egress side.

### TECHNICAL FIELD

The present disclosure generally relates to a message flow shaping technique. Specifically, the disclosure pertains to aspects of triggering a message flow shaping operation in connection with routing of messages in a communication network. The technique presented herein may be implemented in the form of a network element, a message routing system, a method, a computer program, or a combination thereof.

### BACKGROUND

Communication networks are ubiquitous in our connected world. Many larger communication networks comprise a plurality of interconnected network domains. In an exemplary mobile communication scenario, such network domains can be represented by a home network of a roaming subscriber on the one hand and a network visited by the roaming subscriber on the other.

An exchange of messages between network elements located in the same or in different network domains may be based on a session concept. The exchange of messages is also referred to as signalling exchange. There exist various messaging protocols for the exchange of session-based messages. In the above example of message exchanges between network elements of a visited network and a home network, or in other examples, the Diameter protocol is well established. The Diameter protocol is an application layer messaging protocol that provides an Authentication, Authorization and Accounting (AAA) framework for network operators.

In the Diameter protocol, information is exchanged on the basis of request and answer messages. A Diameter message typically identifies the network element originating the message and its logical location in a first network domain (e.g., a client in a visited network) and the message destination with its logical location in a second network domain (e.g., a server in a home network). The identities of the network elements acting as message originator and message destination are indicated by Fully Qualified Domain Names (FQDNs). Their respective logical network location is indicated by their realm (i.e., the administrative network domain where an individual subscriber terminal maintains an account relationship or receives a particular service).

In the Diameter protocol messages are routed on a hop-by-hop basis. To this end, each Diameter server, Diameter client or intermediate Diameter agent (also called proxy) maintains a routing table that associates each directly reachable, or adjacent, peer (“next hop”) with a message destination potentially reachable via that peer. The routing of a request message, for example, is performed on the basis of its destination realm as included in the form of an Attribute Value Pair (AVP) in the message header. A look-up operation in the routing table will yield for a given destination realm the associated next hop to which the message is to be forwarded. In case a particular destination realm is associated with multiple hops in the routing table, a load balancing scheme may be applied to reach the final routing decision.

The messages routed in a communication network may be grouped into individual message flows (sometimes also called traffic flows or simply TFs herein) using suitable message flow definition schemes. Each message flow is a logical entity and typically identified by one or more parameters of a particular message. When message flows have been defined, the routing decision in a network element for an individual message may additionally, or solely, be based on the message flow that message belongs to.

An important aspect of message flow routing is message flow shaping. Message flow shaping in some variants permits a routing network element to protect its peers and other network elements downstream of the message flows (i.e., at an egress side of the network element) from being flooded with messages. To this end, the routing network element can limit the number of messages output at its egress side. As an example, the routing network element may drop or reject individual messages at its egress side to not exceed a predefined message rate or other traffic limit in the downstream direction. Of course, message flow shaping can also be applied at an ingress side of the routing network element.

It has been found that existing message flow shaping approaches do not always provide a consistent reduction of messaging traffic. As an example, in some flow shaping implementations it can become difficult to ensure Quality of Service (QoS) guarantees for certain message flows. As such, high priority services that rely on these message flows may not work properly. In other message flow shaping implementations that rely on the shaping of both ingress message flows and egress message flows, difficulties occur when different flow definition schemes need to be applied at the ingress side and the egress side of the routing network element.

It will be evident that the above and other drawbacks are not specific to a network configuration with multiple domains, to the Diameter protocol or to the roaming scenario as exemplarily described above. Similar problems also occur in other network configurations, other routing-based messaging protocols and other messaging scenarios.

### SUMMARY

Accordingly, there is a need for a solution that avoids one or more of the drawbacks set forth above, or other drawbacks, associated with message flow shaping.

According to a first aspect, a network element capable of messaging routing is presented. The network element is configured to receive one or more logical ingress message flows and to output one or more logical egress message flows, wherein a flow priority level is allocated to each ingress and egress message flow. The network element comprises at least one processor and at least one memory coupled to the at least one processor, the at least one memory storing program code configured to control the at least one processor to determine a message flow congestion state per flow priority level at an egress side of the network element, and to trigger a message flow shaping operation per flow priority level at an ingress side of the network element dependent on the congestion state determined for at least one associated flow priority level at the egress side.

There may exist a predefined association between ingress side flow priority levels and egress side flow priority levels. Such an association may be defined via mapping tables or otherwise. In case a common prioritisation scheme is applied at the ingress side and the egress side of the network element, the association may simply be defined by a one-to-one correspondence of ingress side and egress side priority levels.

In a first implementation, the network element is configured to output multiple egress message flows. In such a case the program code may be configured to control the at least one processor to determine the congestion state for a given flow priority level across the egress message flows allocated to that flow priority level. As such, two or more egress message flows may be allocated to an individual flow priority level and the congestion state for that flow priority level may be determined taking into account these two or more egress message flows.

In a second implementation that may be combined with the first implementation, the network element is configured to receive multiple ingress message flows. In such a case the program code may be configured to control the at least one processor to trigger the message flow shaping operation for a given flow priority level across the ingress message flows allocated to that flow priority level. A particular flow shaping operation for a given flow priority level may thus be applied to all ingress message flows to which that flow priority level has been allocated.

The program code may be configured to control the at least one processor to group ingress messages by one or more ingress flow definition schemes to the one or more logical ingress message flows. Additionally, or as an alternative, the program code may be configured to control the at least one processor to group egress messages by one or more egress flow definition schemes to the one or more logical egress message flows.

The one or more ingress flow definition schemes may be identical to the one or more egress flow definition schemes. Alternatively, the ingress flow definition schemes may be different from the egress flow definition schemes. In such a case, ingress messages grouped to a single logical ingress message flow may be output via two or more different logical egress message flows. Similarly, ingress messages received via two or more logical ingress message flows may be output via a single logical egress message flow.

The program code may be configured to control the at least one processor to apply at least one prioritisation scheme to the ingress message flows and egress message flows to allocate the flow priority levels. In one variant, a first prioritisation scheme may be applied to the ingress message flows and a second, different prioritisation scheme may be applied to the egress message flows. In another variant, a common prioritisation scheme is applied to the ingress message flows and egress message flows.

The message flow prioritisation can be performed in many ways and take into account one or more parameters. As an example, the message flows may be associated with services that have different service priority levels. In such a case the program code may be configured to control the at least one processor to allocate message flows that are associated with services having the same service priority level to the same flow priority level. There may, but need not, exist a one-two-one correspondence between service priority levels on the one hand and flow priority levels on the other.

The program code may be configured to control the at least one processor to trigger the message flow shaping operation in a service priority-aware manner. For example, the scope of the message flow shaping operation (e.g., in terms of dropped or rejected messages) may increase with decreasing priority level of the services that generate the message flows.

The program code may be configured to control the at least one processor to trigger a message flow shaping operation at the egress side, for example per flow priority level. Thus, message flow shaping operations may be performed both at the ingress side and the egress side of the network elements.

The program code may be configured to control the at least one processor to determine the congestion state for a given flow priority level based on a scope of the egress side message flow shaping operation for that flow priority level. As such, an increased congestion may be determined when the scope of the message flow shaping operation increases, and vice versa.

The egress side message flow shaping operation may be configured to operate on at least one message rate limit per flow priority level. For example, the egress side message flow shaping operation may be configured to observe a predefined message rate limit. Different message rate limits may be defined for different flow priority levels and, optionally, different links.

The egress side message flow shaping operation may be configured to observe the at least one message rate limit for a given flow priority level by preventing an output of individual messages that belong to an egress message flow to which that priority level is allocated. The output of individual messages may be prevented by dropping or rejecting individual messages. As such, the program code may be configured to control the at least one processor to determine the congestion state for a given flow priority level based on a ratio between messages that have been output and messages that have been prevented from being output at the egress side.

The ingress side message flow shaping operation may be configured to drop or reject individual messages at the ingress side. For example, the program code may be configured to control the at least one processor to trigger the ingress side message flow shaping operation such that a dropping or rejection ratio for a given flow priority level is dependent on the congestion state determined for the at least one associated flow priority level at the egress side. The dropping or rejection ratio at the ingress side may generally increase with an increasing congestion the egress side.

The network element is in one variant configured to receive multiple ingress message flows via a multiple links. In such a case the program code may be configured to control the at least one processor to trigger the ingress side message flow shaping operation per link. In a similar manner the network element may be configured to output multiple message flows via a multiple links. Also in such a case, the program code may be configured to control the at least one processor to determine the congestion state per link. The program code may be configured to control the at least one processor to trigger the ingress side message flow shaping operation per link dependent on the congestion state determined for at least one associated link at an egress side. The association between ingress side links and egress side links may be defined in a mapping table or otherwise.

In one implementation the network element is configured as a dedicated routing node in the communication network. In an alternative implementation, the network element is configured from cloud computing resources. Further, the network element may be orchestrated by cloud computing resources. The cloud computing resources may be distributed within a single data center or over multiple data centers, regions, network nodes or devices.

The messages may belong to an application layer protocol. Alternatively, or in addition, the messages may belong to a protocol that implements hop-by-hop routing. The transmission of messages may be based on a session or context concept. The messages may belong, for example, to one or more of the Diameter protocol, the Radius protocol, the Hypertext Transfer Protocol (HTTP), the Session Initiation Protocol (SIP) or the Mobile Application Part (MAP) protocol.

According to a further aspect, a message routing system is presented. The system comprises the network element presented herein as a first network element, at least one second network element coupled to the first network element via an ingress side link, and at least one third network element coupled to the first network element via an egress side link. As explained above, multiple second network elements may be coupled to the first network element via multiple ingress side links. In a similar manner multiple third network elements may be coupled to the first network element via multiple egress side links.

Also presented is a method for controlling a network element capable of message routing, wherein the network element is configured to receive one or more logical ingress message flows and to output one or more logical egress message flows, and wherein a flow priority level is allocated to each ingress and egress message flow. The method comprises determining a message flow congestion state per flow priority level at an egress side of the network element, and triggering a message flow shaping operation per flow priority level at an ingress side of the network element dependent on the congestion state determined for at least on associated flow priority level at the egress side.

Also provided is a computer program product comprising program code portions to perform the steps of any of the methods and method aspects presented herein when the computer program product is executed by one or more processors. The computer program product may be stored on a computer-readable recording medium such as a semiconductor memory, hard-disk or optical disk. Also, the computer program product may be provided for download via a communication network.

### BRIEF DESCRIPTION OF THE DRAWINGS

Further aspects, details and advantages of the present disclosure will become apparent from the following description of exemplary embodiments and the drawings, wherein:

FIG. 1 illustrates an embodiment of a message routing system with network elements according to further embodiments of the present disclosure;

FIG. 2 illustrates another message routing system embodiment with further embodiments of network elements;

FIG. 3 illustrates an embodiment of a routing table for a network element;

FIG. 4 illustrates a further message routing system embodiment.

FIG. 5 illustrates a flow diagram of a method embodiment of the present disclosure;

FIG. 6 illustrates a schematic diagram of egress side message flow shaping; and

FIG. 7 illustrates a schematic diagram of ingress side message flow shaping.

### DETAILED DESCRIPTION

In the following description, for purposes of explanation and not limitation, specific details are set forth, such as specific network domains, protocols, and so on, in order to provide a thorough understanding of the present disclosure. It will be apparent to one skilled in the art that the present disclosure may be practiced in embodiments depart from these specific details. For example, while some of the following embodiments will be described in the exemplary context of the Diameter protocol, it will be apparent that the present disclosure could also be implemented using, for example, other application layer messaging protocols that use hop-by-hop routing. Moreover, while the present disclosure will partially be described in an exemplary roaming scenario, the present disclosure may also be implemented in connection with other communication scenarios.

Those skilled in the art will further appreciate that the methods, services, functions and steps explained herein may be implemented using individual hardware circuitry, using software in conjunction with a programmed processor or general purpose computer, using an Application Specific Integrated Circuit (ASIC) and/or using one or more Digital Signal Processors (DSPs). It will also be appreciated that the present disclosure could be implemented in connection with one or more processors and a memory coupled to the one or more processors, wherein the memory is encoded with one or more programs that cause the at least one processor to perform the methods, services, functions and steps disclosed herein when executed by the processor.

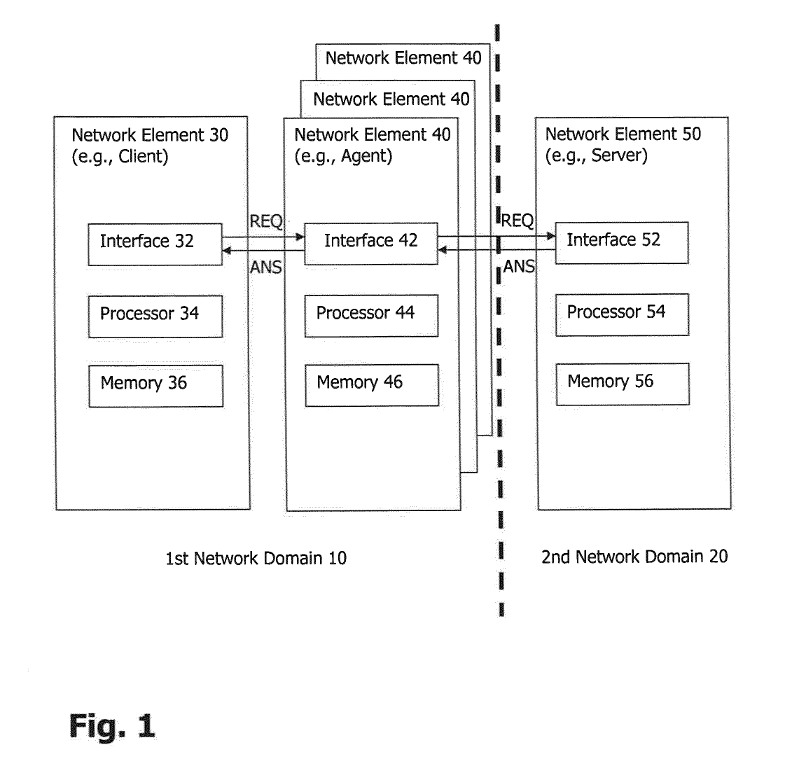

FIG. 1 illustrates an embodiment of a message routing system comprising a first network domain 10 and a second network domain 20. As an example, the first network domain 10 can be a visited network domain while the second network domain 20 is a home network domain (from the perspective of a roaming subscriber not shown in FIG. 1). Each of the two network domains 10, 20 can be a closed domain operated, for example, by a specific Internet Service Provider (ISP), mobile network operator or other service provider.

In the exemplary scenario illustrated in FIG. 1, two or more network elements 30, 40 are located in the first network domain 10 while at least one further network element 50 is located in the second network domain 20. The network element 40 is an intermediary component capable of message routing between the network element 30 on the one hand and the network element 50 on the other.

The network element 30 in the first network domain 10 and the network element 50 in the second network domain 20 may have a client/server relationship in accordance with a dedicated application layer messaging protocol, such as HTTP, MAP, SIP Diameter or Radius. Each of the network elements 30, 50 may be operated as one or both of a client or server depending on its current role in a given messaging transaction. In practice, multiple client/server pairs (in terms of multiple network elements 30 and multiple network elements 50) will be present in the message routing system of FIG. 1.

The at least one intermediary network element 40 is configured to act as an agent (also called proxy) with message routing capabilities between the first network domain 10 and the second network domain 20. It should be noted that one or more further network elements, in particular agents, may operatively be located between the network element 30 and the network element 40 in the first network domain 10. Moreover, one or more further network elements, in particular agents, and, optionally, network domains may operatively be located between the network element 40 in the first network domain 10 and the network element 50 in the second network domain 20.

In other embodiments, the network element 40 could be located in the second network domain 20 or in any intermediate network domain (not shown) between the first network domain 10 and the second network domain 20. In still further embodiments, all the network elements 30, 40, 50 may be located within one and the same network domain, or there may be no network domain differentiation at all in the message routing system.

As shown in FIG. 1, each of the network elements 30, 40, 50 comprises at least one interface 32, 42, 52 and at least one processor 34, 44, 54. Further, each network element 30, 40, 50 comprises a memory 36, 46, 56 for storing program code to control the operation of the respective processor 34, 44, 54 and for storing data. The data may take the form of a routing table with one or more table entries as will be explained in greater detail below.

The interfaces 32, 43, 52 are generally configured to receive and transmit messages from and/or to other network elements. As illustrated in FIG. 1, an exemplary messaging transaction may comprise the transmission of a request message REQ from the network element 30 to the network element 40 and a forwarding, via the network element 40, of the request message REQ to the network element 50. The network element 50 may respond to the request message REQ from the network element 30 with an answer message ANS that is forwarded via the same network element 40 (or a different network element 40) to the network element 30 that initiated the request message REQ. It will be appreciated that the present disclosure is not limited to the exemplary request/answer messaging process illustrated in FIG. 1.

The interface 42 of the network element 40 may logically comprise an ingress side interface part and an egress side interface part. The ingress side interface part is configured to receive one or more logical ingress message flows, while the egress side interface part is configured to output one or more logical egress message flows. In some variants, the terms “ingress” and “egress” as used in connection with the network element 40 may be defined in relation to a client/server location or a request/answer messaging direction. For example, the ingress side of the network element 40 may be defined as the side at which request messages REQ are received from a client (such as the network element 30), while the egress side may be defined to be the side from which request messages REQ are forwarded to a server (such as the network element 50). It will be appreciated that other definitions of the terms “ingress” and “egress” may be applied depending on the particular use case.

Returning to FIG. 1 the ingress side interface part may be configured to apply an ingress side message flow shaping operation, while the egress side interface part may be configured to apply an egress side message flow shaping operation. It will be appreciated that the interfaces 32, 52 of the network elements 30, 50, respectively, may likewise be configured to differentiate between (and, optionally, to apply the message flow shaping operations to) logical ingress message flows and logical egress message flows.

The present disclosure, in certain embodiments, permits the network elements 30, 40, 50 (i.e., clients, servers and agents) to perform better informed message flow shaping decisions. Better informed message flow shaping decisions also help to speed-up service execution, such as receipt of a final answer message at the network element 30 responsive to a request message directed to the network element 40 or the network element 50.

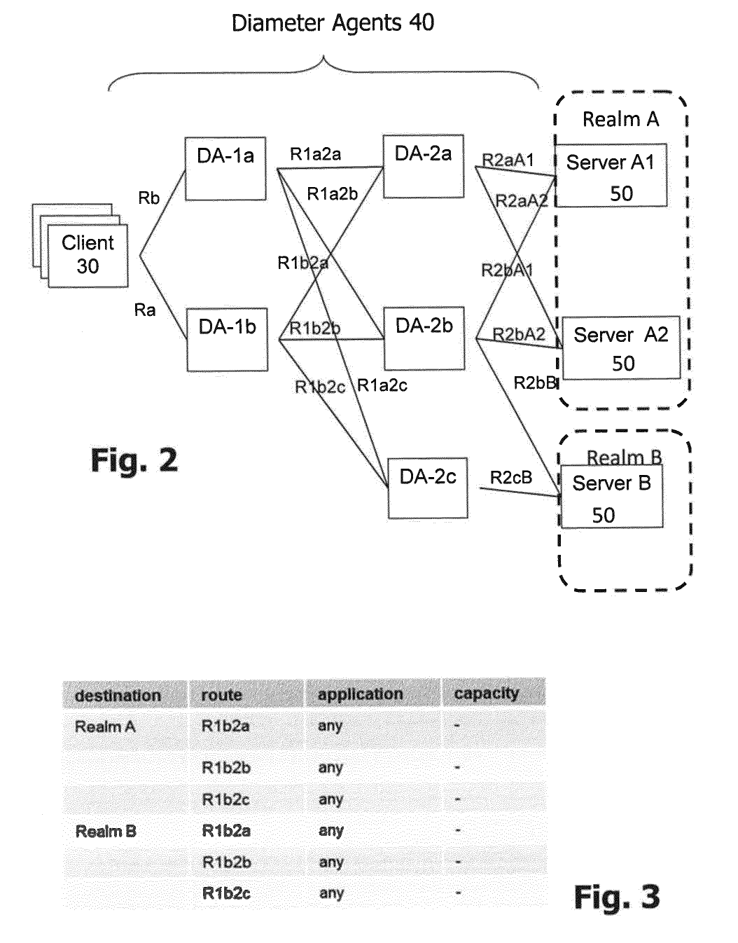

FIG. 2 illustrates an embodiment of a message routing system that may be based on the system of FIG. 1 and that is configured to implement the Diameter protocol. It will be appreciated that the Diameter protocol is only used for illustrative purposes herein and that alternative application layer messaging protocols, in particular such that use hop-by-hop routing, may be implemented as well. The same reference numerals as in FIG. 1 will be used to denote the same or similar components.

In the Diameter-based and other embodiments presented herein, the processing of messages will typically be based on information included in dedicated message fields (AVPs) of these messages. Details in this regard, and in regard of the Diameter protocol in general in terms of the present embodiment, are described in the Internet Engineering Task Force (IETF) Request for Comments (RFC) 6733 of October 2002 (ISSN: 2070-1721).

The network system illustrated in FIG. 2 comprises at least one Diameter client 30 and a plurality of Diameter agents 40 located within one and the same or within different network domains (also denoted as realms in the Diameter protocol). Two further network domains (realm A and realm B) comprise Diameter servers A1, A2 and B, respectively. From the perspective of client 30, realm A and realm B as well as the servers 50 included therein constitute message destinations. Each of the agents 2a, 2b and 2c in FIG. 2 can directly reach a subset of the message destinations. For example, agent 2a can directly reach server A1 and server A2 in realm A, agent 2b can directly reach server A1 and server A2 in realm A as well as server B in realm B, and agent 2c can directly reach server B in realm B.

In FIG. 2, the links between two network elements are denoted by the letter R followed by the two link endpoints. For example, the link between agent 2b and server A2 is denoted “R2bA2”. The corresponding links, or routes, may be entered into a routing table of the respective agent 40 as supported hops.

The routing table of agent 1b may be configured as illustrated in FIG. 3, or in a similar manner. As shown in FIG. 3, the routing table comprises six entries, wherein agent 1b assumes that realm A and realm B can each be reached via each of its next hops (i.e., agent 2a, agent 2b, and agent 2c). It will be appreciated that using suitable typology discovery techniques, the routing table illustrated in FIG. 3 could be corrected to consider that agent 2a cannot reach realm B, while agent 2c cannot reach realm A.

As depicted in FIG. 3, for each route, or link, a service (as provided by a particular application) reachable via that link may be entered into the routing table. Also, a link capacity (e.g., in terms of a particular maximum message rate) may be entered into the routing table per link. The link capacity per link may further be differentiated on the basis of individual message flows or individual message flow priority levels as will be discussed in greater detail below.

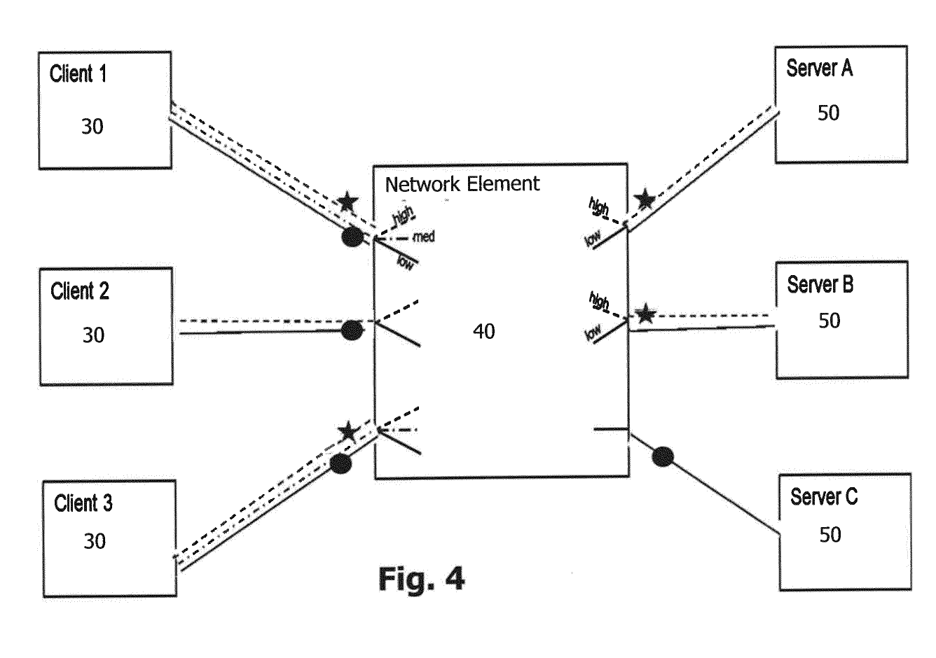

FIG. 4 shows another embodiment of a message routing system according to the present disclosure. The system of FIG. 4 may be based on the system(s) discussed above with reference to one or both of FIG. 1 and FIG. 2. As such, the same reference numerals will again be used to denote the same or similar components.

As shown in FIG. 4, the network element 40 (e.g., an agent with routing capabilities) has three ingress side links and three egress side links. The ingress side links each terminate at a dedicated client 30, while the egress side links each terminate at a dedicated server 50. It will be appreciated that one or more further network elements 40 may be present between the network element 40 and each of the clients 30 and server 50 (see, e.g., FIGS. 1 and 2 in this regard).

Via each individual link, the network element 40 receives multiple logical ingress message flows. In a similar manner, the network element 40 is configured to output multiple logical egress flows on each link towards the servers 50. To each ingress and egress message flow a dedicated flow priority level is allocated. The different flow priority levels of the different message flows are indicated by different line types. In the present, exemplary scenario, three different flow priority levels (high, medium and low) are defined. It will be appreciated that more or less flow priority levels could be allocated in other embodiments. It will also be appreciated that each flow priority level (i.e., line type in FIG. 4) may be associated with one or more message flows that share the corresponding flow priority level.

The grouping of ingress messages to the logical ingress message flows and the grouping of egress messages to the logical egress message flows is performed internally within the network element 40 in accordance with one or more ingress flow definition schemes and one or more egress flow definition schemes, respectively. The ingress flow definition schemes may be the same as the egress flow definition schemes, or different flow definition schemes may be applied at the ingress side and the egress side of the network element 40. The respective flow definition schemes may be defined by one or more message parameters, including the underlying messaging protocol (e.g., MAP, SIP, Diameter, Radius or HTTP), the respective messaging service or interface (e.g., Gr for MAP, S6a or Gx for Diameter, etc.), a message or command code (e.g., Update Location for MAP, Invite Method for SIP, CCR for Diameter, etc.), the presence of one or more dedicated Information Elements (IEs) and/or AVPs in a message, the content of any IE and/or AVP contained in a message (IMSI number, Location Update flags, access types, etc.), an application identifier (an application identified by an application identifier may realize one or more services, see also FIG. 3), and any combination thereof.

Each message flow can be associated with a specific service (or application) generating the messages in that message flow. As understood herein, services can be end-user services but also network-internal services like backup services, charging services, policy control services, location update services or session setup services.

The flow priority level allocated to a particular message flow may reflect the associated service priority level. As such, a single flow priority level may be allocated to message flows pertaining to different services provided that the services have the same or, in general, an associated service priority level. As will be explained below, this allocation mechanism permits the network element 40 to throttle message traffic in a service priority-aware manner upon determining a congestion state. In such a manner, preferences of a network operator in terms of QoS can be reflected.

In the exemplary scenario illustrated in FIG. 4, the network element 40 is configured to throttle message traffic from one or more of the clients 30 at its ingress side upon determining a congestion situation for one or more of the servers 50 at its egress side. For each client 30 only those message flows are throttled that cause the congestion state on the associated server link according to the service implementation (e.g., depending on which message flows implement the service).

In FIG. 4, two congestion states at the egress side of the network element 40 towards the servers 50 are depicted. The star indicates a congestion state for high priority message flows to servers A and B, while the dot represents a congestion state for a low priority message flow to server C. The star and dot are also used to depict the corresponding flow shaping operations at an ingress side of the network element 40. In more detail, flow shaping operations for high priority message flows are selectively carried out for the links towards client 1 and client 3, and further flow shaping operations in relation to low priority message flows are carried out in relation for the link towards client 2 and client 3.

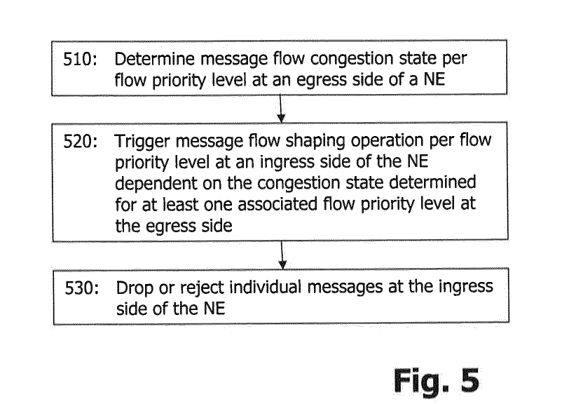

FIG. 5 illustrates a flow diagram of an exemplary method embodiment. The method embodiment will exemplarily be described with reference to the network element 40 and the message routing systems of FIGS. 1, 2 and 4. It will be appreciated that the method embodiment could also be performed using any other network element or message routing system.

The method embodiment illustrated in FIG. 5 can, for example, be performed in connection with subscriber session messaging for a particular subscriber terminal. The subscriber session may be a mobility management session, a charging session, or any other subscriber terminal session.

In a first step 510, the processor 44 of the network element 40 is controlled by program code in the memory 46 to determine a message flow congestion state. The congestion state is determined per flow priority level at an egress side of the network element 40. In the exemplary scenario of FIG. 4, a congestion state may thus be determined for the flow priority level “low” (dot) and the flow priority level “high” (star). In certain variants, such as in the scenario illustrated in FIG. 4, the congestion state may not only be determined per flow priority level, but also per link to a particular server 50.

In a further step 520, the processor 44 is controlled by the program code to trigger one or more message flow shaping operations at an ingress side of the network element 40. The one or more message flow shaping operations at the ingress side are triggered per flow priority level and dependent on the congestion state determined for an associated flow priority level at the egress side. In the exemplary scenario of FIG. 4, message flow shaping operations at the ingress side are triggered for message flows to which the flow priority levels “high” and “low” have been allocated.

The message flow shaping operations at the ingress side can selectively be performed in relation to the links towards the multiple clients 30. In the example of FIG. 4, ingress side flow shaping operations are triggered for all message flows having the flow priority level of “low” (i.e., in relation to the links to all three clients 30), whereas message flow shaping operations for message flows having the flow priority level of “high” are only performed in relation to the links to client 1 and client 3. As such, an association may be defined that defines, for example, per egress side link which ingress side link should be subjected to a message flow shaping operation.

Different prioritization schemes may be applied at the ingress side and the egress side of the network element 40 as long as the ingress side and egress side flow priority levels can be associated with each other. As an example, a particular message flow having a flow priority level of “medium” at the ingress side may be allocated to a flow priority level of “high” at the egress side.

Further, in step 530, the message flow shaping operation triggered in step 520 is carried out at the ingress side of the network element 40. To this end, the processor 44 is configured by the program code to drop or reject individual messages at the ingress side of the network element 40. For rejected messages error codes or error messages comprising an error code may be transmitted back to the originating clients 30 to convey the reason for a rejection. Whether to drop or to reject an individual message may be decided based on the protocol type in use or based on the current state of that protocol.

In certain implementations, message rate limits may be defined per flow priority level and, optionally, per link. In such a case, a congestion state may be determined in case a particular message rate limit is reached or exceeded.

Steps 510 to 530 illustrated in FIG. 5 may be performed at regular time intervals or on a random basis. Additionally, or in the alternative, steps 510 to 530 may be performed upon detection of a particular event (e.g., a change of a network condition).

In some cases, the determination of the congestion state in step 510 may be performed taking into account the ratio of messages that have been prevented from being output at the egress side (e.g., that have been dropped or rejected) and messages that have actually been output. The congestion state may be represented by a non-binary value that increases with the ratio of messages that have been prevented from being output. In the following, one exemplary mechanism for determining the congestion state will be described in more detail.

The function f in the algorithm

Cong-state=f(MSG dropped/rejected over MSG sent)

defines the sensitivity of the calculated Cong-state value and can be set individually per priority level.

The Cong-state value for the flow priority level of “high” can, for example, be set to:
1^{st} case: 1 when the ratio is 5% to 20%, 2 when 20% to 50%, 3 when above 50%,
2^{nd} case: 1 when the ratio is 2% to 5%, 2 when 5% to 50%, 3 when above 50%.

In the second case the sensitivity is higher (i.e., the congestion state is set to a relatively high value when the number of dropped or rejected messages increases slightly).

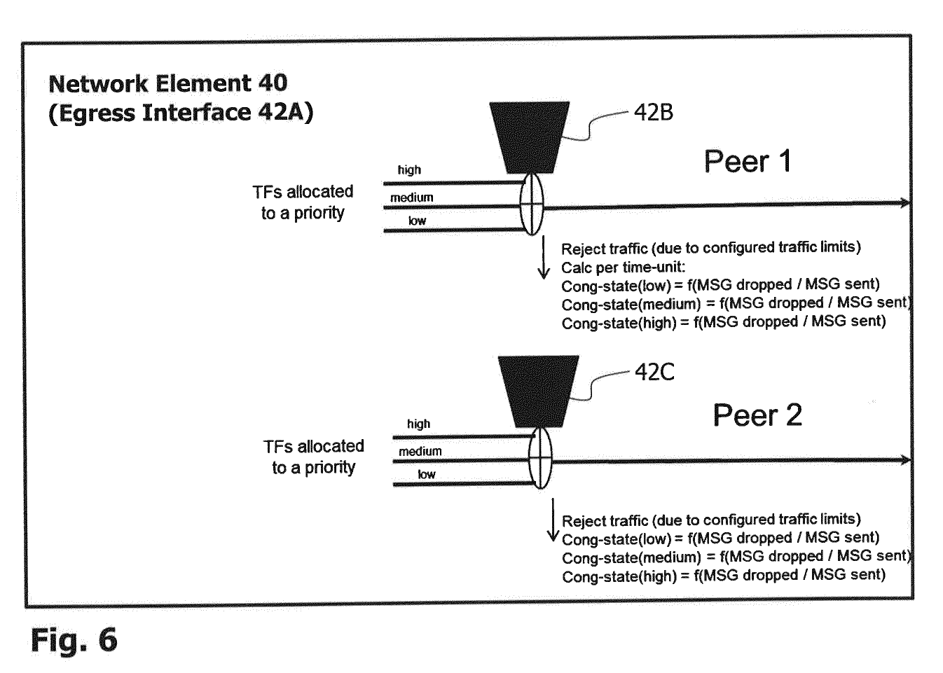

FIG. 6 depicts the egress side interface part 42A of the network element 40 with two links towards Peer 1 and Peer 2 (e.g., server A and server B in the exemplary scenario shown in FIG. 4). At the egress side, message flow shaping is performed per flow priority level and per link. In the exemplary embodiment of FIG. 6, message flow shaping is performed in accordance with the “leaky bucket” concept (see “leaky buckets” 42B and 42C). That concept may operate on the basis of predefined message rate limits per flow priority level and, optionally, per link. As generally known in the art, the “leaky bucket” concept leads to a dropping or rejection of messages when the message rate limits (also called “traffic limits” are reached or exceeded. Based on the ratio of dropped/rejected messages and messages that have actually been sent, the congestion state per flow priority level and link may be determined (see step 510 in FIG. 5) using, for example, the algorithm presented above.

In the particular embodiment of FIG. 6, messages are rejected to meet preconfigured traffic limits. To this end the congestion state per flow priority level (low, medium and high) is calculated in regular time intervals (i.e., per time unit). The congestion state is calculated using the algorithm presented above. It will be appreciated that other algorithms could be used as well.

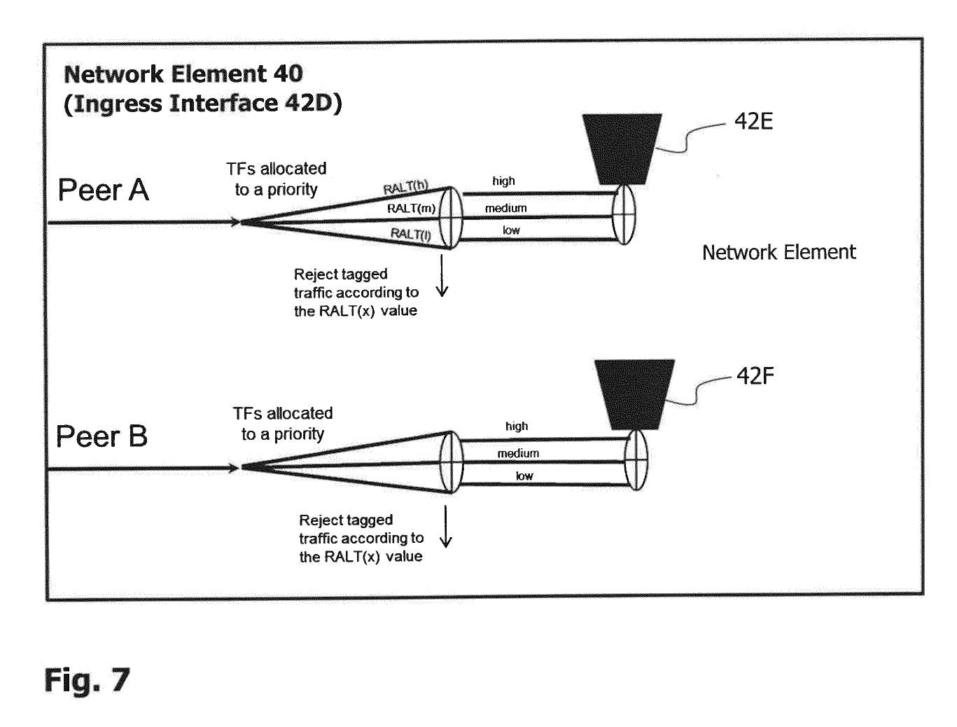

FIG. 7 shows the ingress side message flow handling. Specifically, the ingress side interface part 42D of the network element 40 is depicted with two ingress links towards Peer A and Peer B (e.g., client 1 and client 2 in FIG. 4). As shown in FIG. 7, ingress side message flow shaping is again performed per flow priority level and per link using the exemplary “leaky bucket” concept (see reference numerals 42E and 42F).

The message rate limits for a certain flow priority level on the ingress side are thus not statically configured, but are dynamically calculated based on the Cong-state value of the associated egress side priority level. This approach allows that ingress message flows of a specific priority level can be throttled depending on the congestion state of completely different message flows on the egress side of the network element 40.

In this regard, the network element 40 calculates a so-called RALT value (Relative Allowed Traffic rate) individually per each ingress message flow (or priority level). The RALT value indicates how much the message rate per priority level shall be reduced compared to the current message rate (or compared to any statically configured maximum allowed message rate).

A RALT (low) value of 0% indicates that the current (or statically maximally configured) message rate limit for all message flows with priority level “low” shall not be changed.

A RALT (low) value of y% indicates that the current (or statically maximally configured) message rate shall be reduced by y%.

The individual RALT values per flow priority level are calculated similar to the Cong-state values periodically by the network element 40 and are applied for message flow shaping for a period of time until the next value is calculated and applied. When there is no congestion determined, then the RALT values will be set to 0 and no ingress message flow shaping will occur.

The RALT values can be calculated by taking into account many Cong-state values for different priority levels of the egress side. Some examples for Diameter traffic are given below. However, the same principles can be applied also to a mix of, e.g., SIP- and HTTP-based message flows. It should be noted that ingress message flows can be completely different compared to egress message flows. Ingress message flows can be, e.g., MAP-based while egress message flows can be Diameter and/or SIP based (which would typically be the case for protocol converter agents/nodes 40).

In the particular embodiment of FIG. 7, messages to be rejected are tagged using the calculated RALT value and the tagged message are rejected. It will be appreciated that algorithms other than RALT as defined above could be used as well.

Assume in regard of FIG. 6 that for Peer 1 we have defined Cong-state (low)=1 for 1%-15%, and for Peer 2 Cong-state (low)=1 for 1% to 40%, Cong-state (low)=2 for 41% to 100%.

### Example 1

### Low Congestion

When the congestion level of Peer 1 for message flows of a low priority level is below 15%, then throttle 30% of low priority message flows on ingress for Peer A and 10% for Peer B (see FIG. 7)

(cong-state(low)=1 and peer=Peer1) set (RALT(low) of peer=PeerA to 30% and RALT(medium) of peer=PeerB to 10%) expression 1

### Example 2

### High Congestion

When the congestion level of Peer 1 for message flows of a low priority level is above 15% and for Peer 2 above 41% then throttle 70% of low priority message flows on ingress for Peer A and 50% of medium priority message flows on Peer B

(cong-state(low)>1 and peer=Peer1) and (cong-state(low)=2 and peer=Peer2) set (RALT(low) of peer=PeerA to 70% and RALT(low) of peer=PeerB to 100% and RALT(medium) of peer=PeerB to 50%) expression 2

As has become apparent from the above exemplary embodiments, the solution presented herein permits a management of congestion situations taking into account service priority levels (as defined, e.g., by network operators for their individual networks). In congestion situations traffic can be consistently throttled (e.g., per user or user group) for individual services or individual network elements taking into account a complete message flow for a service. Messages can be dropped or rejected in congestion situations already at the beginning of a longer-lasting session (and not at the end of it, which would make all previous message exchanges obsolete), so that the already established session can be completed with higher priority, resulting in a higher QoS.

In congestion situations the message flows that cause the actual overloads can be subjected to message flow shaping operations. As an example, a specific message flow type (or traffic type) from clients that cause a server overload can be dropped or rejected.

While the present invention has been described in relation to exemplary embodiments, it is to be understood that the present disclosure is for illustrative purposes only. Accordingly, it is intended that the invention be limited only by the scope of the claims appended hereto.

1-26. (canceled)

27. A network element capable of message routing, the network element being configured to receive one or more logical ingress message flows and to output one or more logical egress message flows, wherein a flow priority level is allocated to each ingress and egress message flow, the network element comprising:
processing circuitry;
memory containing instructions executable by the processing circuitry whereby the processing circuitry is operative to:
determine a message flow congestion state per flow priority level at an egress side of the network element; and
trigger a message flow shaping operation per flow priority level at an ingress side of the network element dependent on the congestion state determined for at least one associated flow priority level at the egress side.

28. The network element of claim 27:
wherein the network element is configured to output multiple egress message flows; and
wherein the instructions are such that the processing circuitry is operative to determine the congestion state for a given flow priority level across the egress message flows allocated to that flow priority level.

29. The network element of claim 27:
wherein the network element is configured to receive multiple ingress message flows; and
wherein the instructions are such that the processing circuitry is operative to trigger the message flow shaping operation for a given flow priority level across the ingress message flows allocated to that flow priority level.

30. The network element of claim 27, wherein the instructions are such that the processing circuitry is operative to:
group ingress messages by one or more ingress flow definition schemes to the one or more logical ingress message flows; and
group egress messages by one or more egress flow definition schemes to the one or more logical egress message flows.

31. The network element of claim 30, wherein the one or more ingress flow definition schemes are different from the one or more egress flow definition schemes.

32. The network element of claim 27, wherein the instructions are such that the processing circuitry is operative to apply at least one prioritization scheme to the ingress message flows and egress message flows to allocate the flow priority levels.

33. The network element of claim 32:
wherein the message flows are associated with services that have different service priority levels; and
wherein the instructions are such that the processing circuitry is operative to allocate message flows that are associated with services having the same service priority level to the same flow priority level.

34. The network element of claim 27, wherein the instructions are such that the processing circuitry is operative to trigger a message flow shaping operation at the egress side per flow priority level.

35. The network element of claim 34, wherein the instructions are such that the processing circuitry is operative to determine the congestion state for a given flow priority level based on a state of the egress side message flow shaping operation for that flow priority level.

36. The network element of claim 34, wherein the egress side message flow shaping operation is configured to operate on at least one message rate limit per flow priority level.

37. The network element of claim 36, wherein the egress side message flow shaping operation is configured to observe the at least one message rate limit for a given flow priority level by preventing an output of individual messages that belong to an egress message flow to which that flow priority level is allocated.

38. The network element of claim 37, wherein the instructions are such that the processing circuitry is operative to determine the congestion state for a given flow priority level based on a ratio between messages that have been output and messages that have been prevented from being output at the egress side.

39. The network element of claim 27, wherein the ingress side message flow shaping operation is configured to drop or reject individual messages at the ingress side.

40. The network element of claim 39, wherein the instructions are such that the processing circuitry is operative to trigger the ingress side message flow shaping operation such that a dropping or rejection ratio for a given flow priority level is dependent on the congestion state determined for the at least one associated flow priority level at the egress side.

41. The network element of claim 27:
wherein the network element is configured to receive multiple ingress message flows via multiple links; and
wherein the instructions are such that the processing circuitry is operative to trigger the ingress side message flow shaping operation per link.

42. The network element of claim 27:
wherein the network element is configured to output multiple egress message flows via multiple links; and
wherein the instructions are such that the processing circuitry is operative to determine the congestion state per link.

43. The network element of claim 41, wherein the instructions are such that the processing circuitry is operative to trigger the ingress side message flow shaping operation per ingress side link dependent on the congestion state determined for at least one associated egress side link.

44. A message routing system, the system comprising:
a first network element capable of message routing, the first network element being configured to receive one or more logical ingress message flows and to output one or more logical egress message flows, wherein a flow priority level is allocated to each ingress and egress message flow, the first network element comprising:
processing circuitry;
memory containing instructions executable by the processing circuitry whereby the processing circuitry is operative to:
determine a message flow congestion state per flow priority level at an egress side of the network element; and
trigger a message flow shaping operation per flow priority level at an ingress side of the network element dependent on the congestion state determined for at least one associated flow priority level at the egress side;
at least one second network element coupled to the first network element via an ingress side link; and
at least third network element coupled to the first network element via an egress side link.

45. A method of controlling a network element capable of message routing, the network element being configured to receive one or more logical ingress message flows and to output one or more logical egress message flows, wherein a flow priority level is allocated to each ingress and egress message flow, the method comprising:
determining a message flow congestion state per flow priority level at an egress side of the network element; and
triggering a message flow shaping operation per flow priority level at an ingress side of the network element dependent on the congestion state determined for at least one associated flow priority level at the egress side.

46. A non-transitory computer readable recording medium storing a computer program product for controlling a network element capable of message routing, the network element being configured to receive one or more logical ingress message flows and to output one or more logical egress message flows, wherein a flow priority level is allocated to each ingress and egress message flow, the computer program product comprising software instructions which, when run on processing circuitry of the network element, causes the network element to:
determine a message flow congestion state per flow priority level at an egress side of the network element; and
trigger a message flow shaping operation per flow priority level at an ingress side of the network element dependent on the congestion state determined for at least one associated flow priority level at the egress side.
